(19) United States
(12) Patent Application Publication
(10) Pub. No.: US 2018/0225999 A1
(43) Pub. Date: Aug. 9, 2018

(54) DOUBLE-SIDED PRINTABLE LABEL SYSTEM

(71) Applicant: Premier Print & Services Group, Inc., Chicago, IL (US)

(72) Inventor: Bruce A. Raming, Northbrook, IL (US)

(73) Assignee: Premier Print & Services Group, Inc., Chicago, IL (US)

(21) Appl. No.: 15/429,000

(22) Filed: Feb. 9, 2017

(51) Int. Cl. G09F 3/10; G09F 3/00

(52) U.S. Cl. CPC G09F 3/10; G09F 2003/0229; G09F 3/0291

(57) ABSTRACT

A duplex label includes a label stock presenting opposite top and bottom faces that correspond to a label top and a label bottom, respectively. The label top is printable to receive exposed indicia that is visible when the label is adhered to the substrate. A pattern of adhesive is applied to only part of the bottom face of the label stock so as to define an adhesive portion of the label bottom. An area of selectively activated print coating is preapplied to only part of the bottom face of the label stock so as to define a printable portion of the label bottom. The printable portion is operable to receive hidden indicia when the print coating is activated, with the hidden indicia being concealed cooperatively by the label stock and substrate until the label is at least partly removed. The adhesive portion and the printable portion are nonoverlapping.

### BACKGROUND

### 1. Field

The present invention relates generally to business forms. More specifically, embodiments of the present invention concern a duplex label system with a selectively activated print coating.

### 2. Discussion of Prior Art

Known adhesive business forms are commonly adhered to a substrate, such as a product or a product container. One example of commercially utilized labels is a packing and shipping label, which is adhered directly to a box, envelope, or other packaging for shipping a product. Prior art labels are provided as separate labels for each package, with the packing label normally being held by the shipping label so that the contents indicia printed on the packing label is hidden from view. Another conventional shipping label comprises a linerless label with an adhesive layer and a printable area on the adhesive face of the label.

Prior art adhesive labels suffer from various undesirable limitations. For example, labels with a liner are problematic because they involve the use of a label stock, an adhesive pattern on the label stock, and a liner that covers the adhesive pattern when both sides of the duplex label are printed. When the printed label is ready to be applied to a substrate, a portion of the liner is typically removed from the label stock to expose the adhesive and the removed portion of the liner is typically discarded as waste. The use of a large number of labels generates an undesirable amount of liner waste, and results in an inefficient label application process. Also, the liner is problematic to remove from the label stock using conventional automated label printing and application equipment.

It is also known that some conventional linerless labels have deficiencies. For instance, the adhesive layer on the adhesive face is known to interfere with printing of the adhesive face. In particular, the adhesive can become caught in a print head and obstruct the print head from printing on the label. For labels with heat-activated adhesive, the activation process can also change the coloration of areas outside of the adhesive.

### SUMMARY

The following brief summary is provided to indicate the nature of the subject matter disclosed herein. While certain aspects of the present invention are described below, the summary is not intended to limit the scope of the present invention.

Embodiments of the present invention provide a duplex label that does not suffer from the problems and limitations of the prior art labels set forth above.

A first aspect of the present invention concerns a duplex label having a label top and a label bottom, with the label bottom configured to be adhered to a substrate. The duplex label broadly includes a label stock, a pattern of adhesive, and an area of selectively activated print coating. The label stock presents opposite top and bottom faces that correspond to the label top and the label bottom, respectively. The label top is printable to receive exposed indicia that is visible when the label is adhered to the substrate. The pattern of adhesive is applied to only part of the bottom face of the label stock so as to define an adhesive portion of the label bottom. The area of selectively activated print coating is preapplied to only part of the bottom face of the label stock so as to define a printable portion of the label bottom. The printable portion is operable to receive hidden indicia when the print coating is activated, with the hidden indicia being concealed cooperatively by the label stock and substrate until the label is at least partly removed. The adhesive portion and the printable portion are nonoverlapping.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a top view of a linerless duplex label that is part of a linerless duplex label system constructed in accordance with a first embodiment of the present invention, showing a single-ply label stock of the linerless duplex label with an endless border section and a central section, with perforation lines extending between the border and central sections and defining a tear strip providing removable connection of the sections, a selectively activated top print coating that covers the label stock, and a transparent release coating applied to the top print coating, with exposed indicia printed on the label top;

FIG. 2 is a bottom view of the linerless duplex label shown in FIG. 1, showing an adhesive layer applied to a bottom face of the label stock, with the adhesive layer being applied to the endless border section of the label stock, and showing multiple areas of selectively activated bottom print coating preapplied to corresponding parts of the central section, with the bottom print coating being denoted schematically by hatch lines and shown as presenting hidden indicia;

FIG. 3 is a perspective view of a continuous web of single-ply label stock that presents a plurality of the labels (shown in FIGS. 1 and 2) attached end-to-end, with the continuous web being wound in a label roll, and showing the labels prior to being printed with the exposed and hidden indicia;

FIG. 4 is a fragmentary cross sectional view of the linerless duplex label taken along line 4-4 in FIG. 3, showing the label stock, release coating, top and bottom print coatings, and adhesive layer;

FIG. 5 is a top perspective view of the linerless duplex label shown in FIGS. 1 and 2, showing the printed label adhered to a package and the central section in an unsecured configuration where the tear strip is partly removed to present an unsupported margin of the central section, with the central section remaining attached to the border section and the hidden indicia remaining substantially hidden;

FIG. 6 is a top perspective view of the linerless duplex label similar to FIG. 5, but showing the tear strip entirely removed from the adhered label and the central section of the label partly removed from the border section to expose the hidden indicia;

FIG. 7 is a top perspective view of the linerless duplex label system, including the duplex labels shown in FIGS. 1-6, with the system further including a duplex printer, a cutting mechanism, and a label applicator, and showing the system printing linerless duplex labels from the label roll, cutting the printed labels to detach an end-most label from the label roll, and applying the detached label to a package, with the central section in a secured configuration;

FIG. 8 is a fragmentary view of the duplex printer shown in FIG. 7, showing upper and lower print heads located within a printer housing and printing the top and bottom of labels from the label roll;

FIG. 9 is a top view of a linerless duplex label constructed in accordance with a second embodiment of the present invention, showing a border section and a central section of the label, a selectively activated top print coating that covers the label stock, and a transparent release coating applied to the top print coating, with exposed indicia printed on the label top;

FIG. 10 is a bottom view of the linerless duplex label shown in FIG. 9, showing an adhesive layer of the label applied to the border section, and a single area of selectively activated bottom print coating that extends up to but does not overlap the adhesive layer, with the bottom print coating being denoted schematically by hatch lines and shown as presenting hidden indicia;

FIG. 11 is a top view of a linerless duplex label constructed in accordance with a third embodiment of the present invention, showing a border section and a central section of the label, a selectively activated top print coating that covers the label stock, and a transparent release coating applied to the top print coating, with the central section including an unadhered end section to facilitate separation of the central section from the border section;

FIG. 12 is a bottom view of the linerless duplex label shown in FIG. 11, showing an adhesive layer of the label applied to the border section, and a single area of selectively activated bottom print coating that extends up to but does not overlap the adhesive layer, with the bottom print coating being denoted schematically by hatch lines and shown as presenting hidden indicia;

FIG. 13 is a top view of a linerless duplex label constructed in accordance with a fourth embodiment of the present invention, showing a border section and a central section of the label, a selectively activated top print coating that covers the label stock, and a transparent release coating applied to the top print coating, with the central section including a tear strip extending from one side edge of the label to the opposite side edge of the label; and

FIG. 14 is a bottom view of the linerless duplex label shown in FIG. 13, showing an adhesive layer of the label applied to the border section, and a single area of selectively activated bottom print coating that extends up to but does not overlap the adhesive layer, with the bottom print coating being denoted schematically by hatch lines and shown as presenting hidden indicia.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

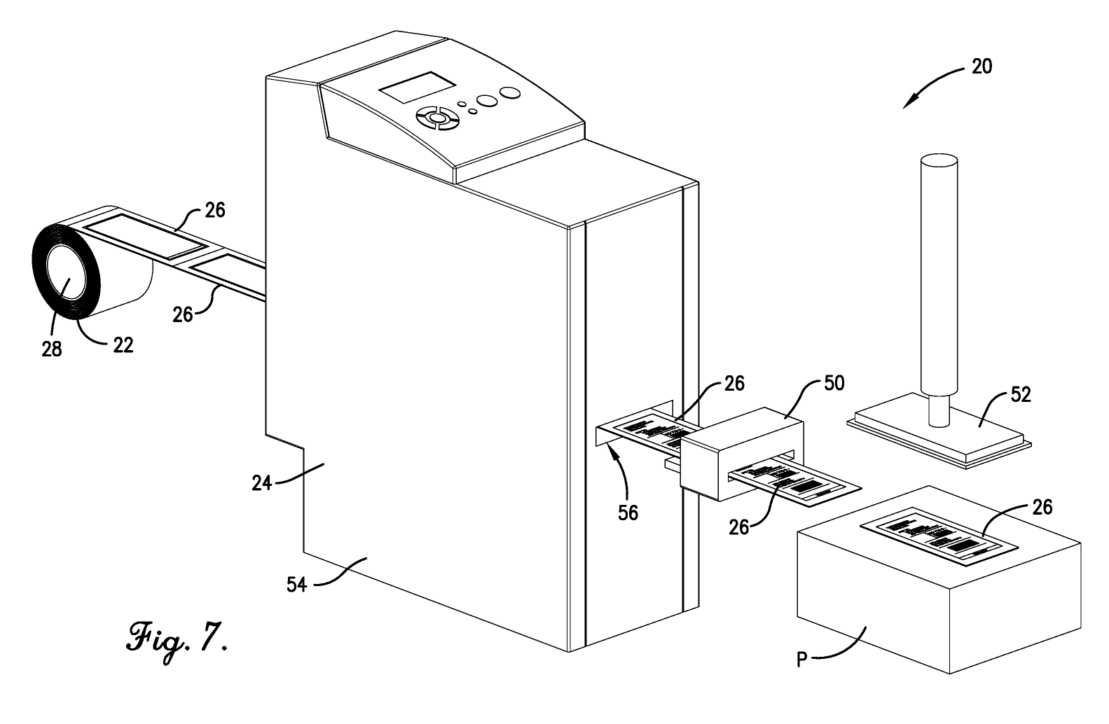

Turning initially to FIG. 7, a duplex label system 20 is constructed in accordance with a first preferred embodiment of the present invention. The label system 20 is configured to provide an adhesive duplex label for application on a package P. The duplex label system 20 broadly includes an overlaid label supply 22 and a duplex printer 24.

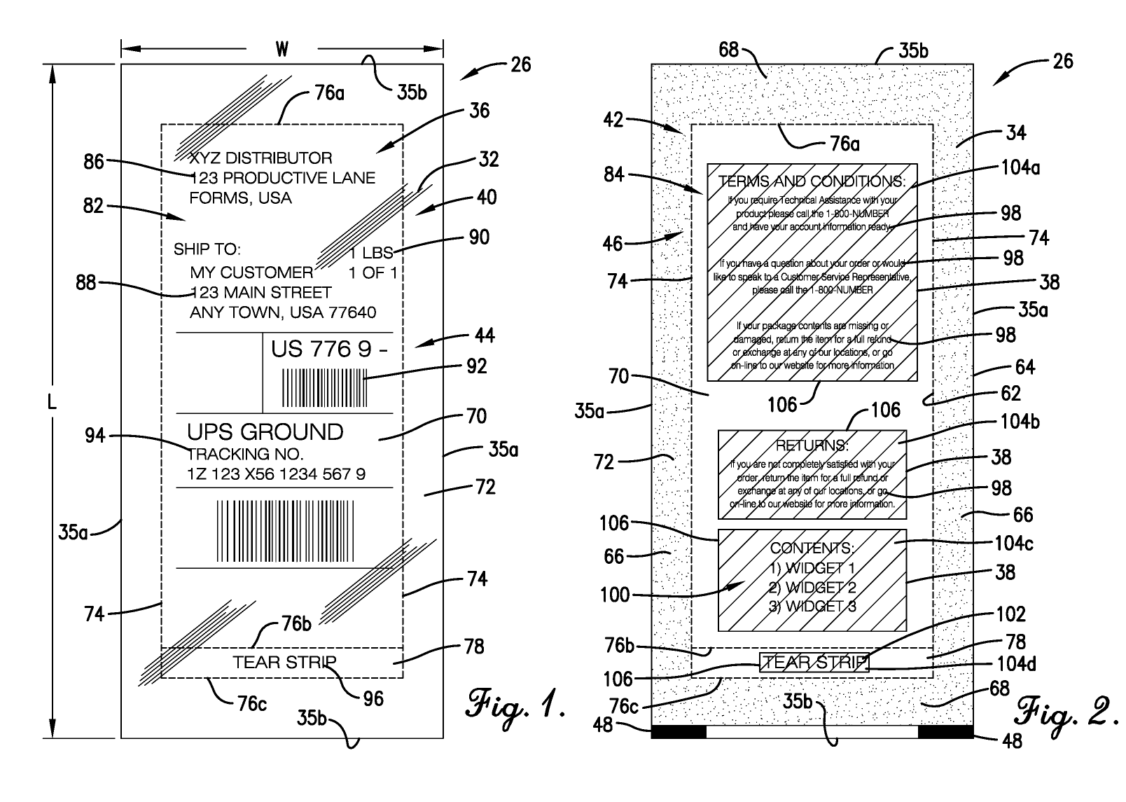

As shown in FIGS. 1-4, the overlaid label supply 22 is preferably in the form of a continuous roll, which provides a plurality of linerless duplex labels for printing and application onto a substrate as a shipping label. However, the label could comprise an alternative shipping label, such as a shipping and packing list label shown in subsequent embodiments. Also, the label could provide a shipping label with a personal note (e.g., where the label is provided with a gift). Yet further, the label could be provided with any item where it is desirable to include individualized indicia and to conceal the indicia. It is also within the ambit of the present invention where the label is applied to items other than packages.

In the illustrated embodiment, the labels are unprinted. However, according to some aspects of the present invention, the labels may be pre-printed with some indicia on either side of the label. The label roll 22 preferably includes a plurality of linerless duplex labels 26 attached end-to-end and a sleeve 28.

In the preferred embodiment, the label roll 22 includes a continuous web of single-ply printer stock 30 (i.e., a label substrate) that presents the end-to-end duplex labels 26, and the continuous web is wound in a roll onto the sleeve 28 (see FIG. 4). As will be discussed further, the labels 26 are individually detachable from the label roll 22. However, for some aspects of the present invention, an alternative printer stock could be used. For example, as will be explained, the stock may alternatively include multiple plies, may include detachable labels arranged in a fanfold supply, or comprise individual label sheets.

The duplex labels 26 are each configured to receive shipping information and broadly include thermal printer stock 30, release coating 32, adhesive layer 34, and top and bottom activated print coatings 36,38 (see FIGS. 1, 2, and 4). The thermal printer stock 30 preferably comprises a label stock for direct-thermal printing, but other types of printer stock could be used without departing from the scope of the present invention.

The illustrated labels are preferably provided as linerless labels. The linerless construction permits the user to expose the adhesive layer 34 of each label 26 by merely separating the label 26 from the label supply 22. However, with respect to at least some embodiments of the present invention, alternative labels could include a liner that is removably adhered to and substantially covers the adhesive layer. In such an alternative embodiment, the liner is selectively removable from the rest of the label to permit application of the label to a package. Details of a suitable label construction with a removable liner are disclosed in U.S. Patent No. RE39,100, issued May 23, 2006, entitled DUPLEX CARTON LABEL/PACKING LIST, which is hereby incorporated in its entirety by reference herein.

The preferred stock 30 includes opposite side edges 35a that define a substantially continuous label width W and opposite end edges 35b that define a label length L (see FIG. 1). Preferably, the width W is in the range of about one inch (1″) to about eight inches (8″) and, more preferably, about three inches (3″) to about five inches (5″). The length L preferably is in the range of about one inch (1″) to about fourteen inches (14″) and, more preferably, about four inches (4″) to about ten inches (10″). It will be appreciated that the label could present an alternative label shape or an alternative label dimension without departing from the scope of the present invention.

The illustrated stock 30 also presents opposite top and bottom faces 40,42 to receive direct-thermal print coatings 36,38 for direct-thermal printing (see FIG. 4). However, for some aspects of the present invention, the stock may alternatively be configured to be printed using another printing method.

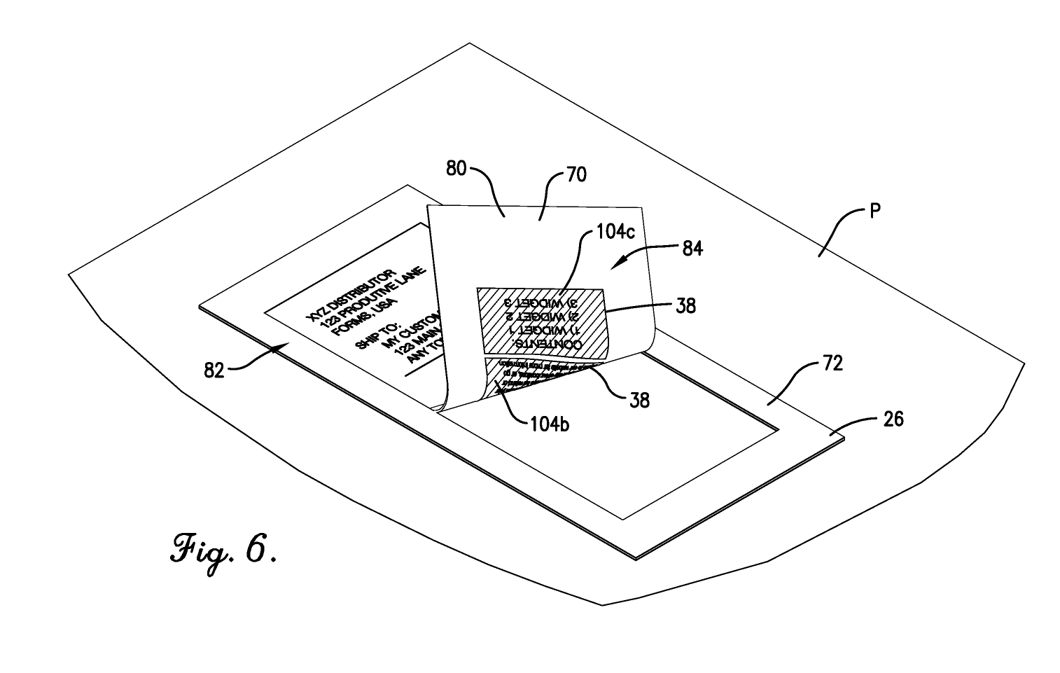

As will be discussed further, the top face 40 of the stock 30, top print coating 36, and release coating 32 cooperatively provide a label top 44 (see FIG. 4). Similarly, the bottom face 42 of the stock 30, adhesive layer 34, and the bottom print coating 38 cooperatively provide a label bottom 46 (see FIG. 4). It is noted that areas of bottom print coating 38 shown in FIGS. 2 and 6 are denoted schematically by hatch lines, and that such hatch lines are not indicia. For subsequent label embodiments depicted herein, the bottom print coatings are similarly illustrated.

Preferably, the labels 26 are attached end-to-end to form the continuous web, and the web is wound to form the roll 22. In particular, the labels 26 are arranged so that the top and bottom faces 40,42 each extend continuously along the length of the web. However, the labels 26 could be provided in the form of an alternative label supply, likely depending on the type of adhesive utilized. For instance, if a temporary or selectively activatable adhesive is utilized, the labels could be provided in a continuous web of detachable labels that are folded in series to form a stack of labels in a fanfold arrangement. Alternatively, the labels could be provided as separate forms detached from one another (e.g., where the labels are stacked in registration with one another).

As will be described, in the illustrated embodiment, the adhesive layer 34 is a pressure sensitive adhesive and the adhesive bottom 46 of the innermost label 26 adhesively engages the sleeve 28. However, alternative adhesives (e.g., selectively activatable adhesives) are within the ambit of certain aspects of the present invention and adhesive connection to the sleeve or the underlying label(s) may not be required (in which case the release coating 32 may be eliminated). As the web is wound to form the roll 22, the label bottom 46 engages and overlies the label top 44 on the roll 22. The release coating 32 on the top face 40 permits removable adhesion between adjacent overlaid labels 26 on the roll 22 so that the labels 26 are removable from each other without becoming damaged. The end-most label 26, i.e., the label at an exposed end of the web, can be removed from overlaid engagement with the label(s) 26 therebelow and can be separated from the web, preferably by using a timing mark indicia 48 defined at one end 35b (see FIG. 2).

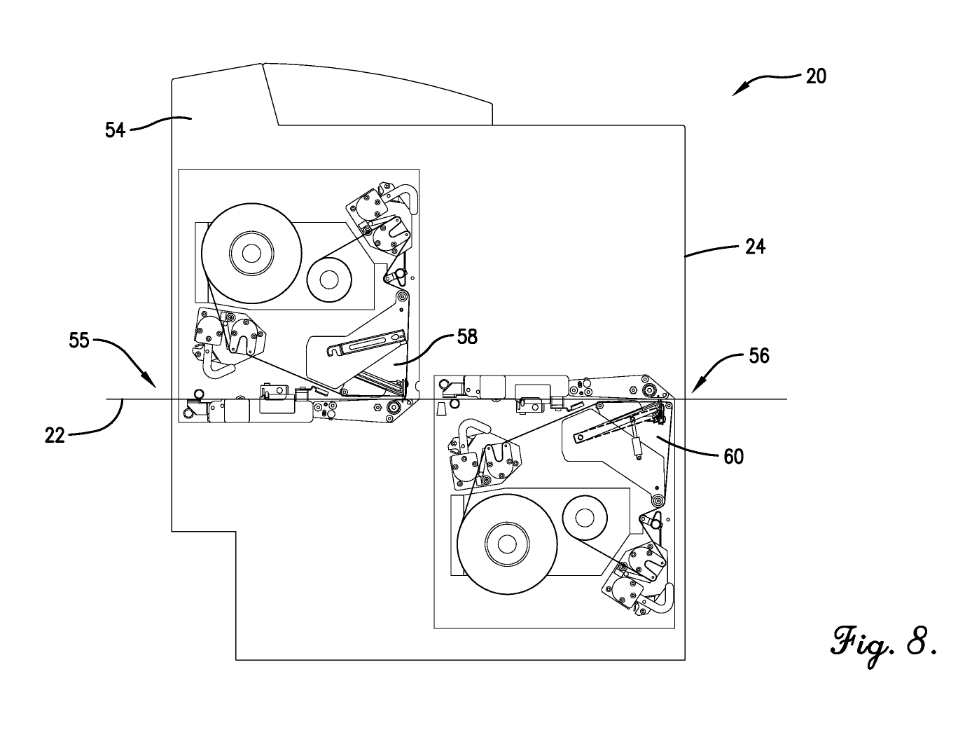

Turning to FIGS. 7 and 8, the linerless duplex label system 20 is configured to print and apply a duplex shipping label to package P and includes the label roll 22, duplex printer 24, cutter 50, and label applicator 52. The duplex printer 24 is configured to print the label 26 in a single printing pass, as will be discussed. The duplex printer 24 includes a housing 54 that presents a form inlet 55 that receives the incoming web and a form outlet 56 through which the printed web is discharged from the printer 24. The duplex printer 24 includes upper and lower print heads 58,60 positioned within the printer housing 54 for printing indicia on the label top and bottom 44,46 (see FIG. 8). The label roll 22 is rotatably supported by a frame (not shown) adjacent the form inlet of the duplex printer 24.

As the web passes through the duplex printer 24, the label top and bottom 44,46 may be printed by the duplex printer 24 either simultaneously or sequentially (e.g., by printing the bottom face 42 after printing the top face 40) during the single printing pass. The single printing pass may likely involve some back-and-forth movement of the label 26 as the label 26 is being printed (e.g., to permit printing of the label 26 by multiple print heads), but it is also within the scope of the present invention where the label 26 is fed continuously through the printer 24 at a constant speed during printing of the label 26.

The illustrated duplex printer 24 is preferably a direct-thermal printer, but the principles of the present invention are equally applicable where the printer 24 includes another type of print head, such as a laser print head for laser reactive marking (LRM) of the print coatings, or a combination of print head types. For instance, the printer 24 could have one type of print head that serves as the upper print head 58 to print the label top 44 and another type of print head spaced below the upper print head and serving as the lower print head 60 to print the label bottom 46. Furthermore, multiple types of print heads could be used to print either the label top or bottom 44,46. For some aspects of the present invention, the printer 24 could additionally include a thermal transfer head, a laser head, or an ink jet head.

Additional preferred details of the illustrated printer 24 and the use thereof are disclosed in U.S. Pat. No. 8,857,943, issued Oct. 14, 2014, entitled DUPLEX PRINTER WITH MOVABLE PRINT HEAD, which is hereby incorporated in its entirety by reference herein.

While all of the illustrated indicia on label 26 is printed by the printer 24 using direct-thermal printing, it is also within the scope of the present invention where at least some of the indicia on label 26 is printed using laser reactive marking. However, for some aspects of the present invention, additional label indicia (beyond the selectively activated print coating 38 of the label bottom 46) could be printed by thermal transfer, laser, or ink jet printing. Furthermore, some of the indicia, particularly the non-variable indicia, could be pre-printed on the continuous web (i.e., prior to printing by the duplex printer 24).

As will be discussed, the linerless duplex label system 20 is operable to print the label 26 on the label top and bottom 44,46 with variable and/or nonvariable indicia. In the illustrated embodiment, all of the variable indicia printed on label 26 is associated with the particular package P, the contents of the package P, and the recipient of the package. Therefore, the system 20 associates (or matches) all of the variable indicia for each label 26 prior to printing of the label 26. For example, the system 20 could include a computer (not shown) for compiling and associating the information for each label 26. The system 20 also provides printing instructions to the printer 24 so that the associated (or matched) indicia is printed on the same label 26. Also, while the illustrated variable indicia is associated with the corresponding package P, some variable indicia could be associated by another type of association (e.g., the recipient address indicia 86 and the account number of the purchase order indicia 88 can be associated with the name of a recipient).

Preferred details of the cutter 50 and the label applicator 52 and the use of these components to separate a printed label 26 from the label supply and apply it to package P are well understood by those ordinarily skilled in the art, and are disclosed in the above-incorporated '943 patent.

The illustrated system 20 is preferably configured to operate as an automatic, electronically operated label print and apply station. However, the principles of the present invention are applicable where steps of the label print and application process are performed manually. Because the system 20 is configured to print variable indicia on both label faces, the system 20 can also apply labels to a plurality of packages P, where each package P has at least some indicia that is different from the other packages P. For instance, the system 20 is operable to print and apply labels to multiple packages P, with each package having different contents and each label 26 having different package contents indicia. Similarly, the recipient address indicia is likely different between each package.

The release coating 32 serves to permit multiple labels 26 to be removably overlaid with one another. The release coating 32 preferably comprises a silicone coating applied in a continuous layer on the top print coating 36 and over the top face 40 of the thermal printer stock 30. Preferably, the layer of release coating 32 extends continuously to cover the top print coating 36 and the entire top face 40. However, the release coating 32 could be alternatively configured without departing from the scope of the present invention. For instance, the release coating 32 could include a material other than silicone for providing a release mechanism. It is also within the scope of the present invention where the release coating 32 does not completely cover the top print coating 36 and/or the top face 40. For example, the release coating could alternatively be print-applied within only a border section (as defined below) of the label 26.

The adhesive layer 34 serves to adhere the label 26 to package P and is most preferably applied in an endless border pattern along the bottom face 42 to present inner and outer adhesive margins 62,64 (see FIG. 2). The illustrated adhesive layer 34 extends outwardly so that the outer adhesive margin 64 extends to edges 35a,b of the stock 30, with substantially no part of the bottom face 42 extending outwardly from the outer adhesive margin 64. This preferred arrangement reduces the risk of inadvertent label removal during shipping. However, the principles of the present invention are also applicable where part of the bottom face 42 extends outwardly from the outer adhesive margin 64, e.g., to provide an outer adhesive-free part of the label 26.

The illustrated adhesive layer 34 extends continuously inwardly from the outer adhesive margin 64 to present side borders 66 and end borders 68 of the endless border pattern, with the inner adhesive margin 62 extending endlessly along the borders 66,68 (see FIG. 2). The inner adhesive margin 62 surrounds a central section 70 of the stock 30 that is preferably adhesive-free along the bottom face 42. Accordingly, an endless border section 72 of the stock 30 is preferably covered with adhesive along the bottom face 42. However, for some aspects of the present invention, adhesive could be applied to part of the central section 70, e.g., to further adhere the label 26 to the package P.

The adhesive layer 34 preferably continuously covers the border section 72. However, as will be shown in a subsequent embodiment, the adhesive layer could present an adhesive border that is not endless. For instance, although the adhesive layer 34 presents four (4) sides of an adhesive border, the adhesive layer 34 could be alternatively shaped to extend along only one (1), two (2), or three (3) sides of the border section 72. The adhesive layer could also present an adhesive border with greater than four sides (e.g., an adhesive border with five (5) or six (6) sides), or each adhesive side may be discontinuous (e.g., with spaced apart adhesive segments defining each side). Furthermore, the adhesive border preferably matches the overall shape of the label, with each side of the label being provided with a corresponding side of the adhesive border. However, such correspondence is not required for certain aspects of the present invention.

The central section 70 is configured to present a printable section of the label bottom 46 (i.e., the adhesive-free section of the label bottom 46), with the adhesive layer 34 preferably surrounding the central section 70 to securely conceal the printable section when the label 26 is applied to package P. However, the principles of the present invention are applicable where another section of the bottom face 42 is printable (e.g., a section spaced outwardly from the adhesive layer 34). For some aspects of the present invention, some printing could be done on parts of the adhesive layer 34 itself.

The illustrated adhesive layer 34 preferably comprises a permanent adhesive. In the illustrated embodiment, the adhesive layer 34 includes a pressure sensitive adhesive. However, the adhesive layer 34 could include an alternative adhesive, such as an activated adhesive. For instance, the adhesive could comprise a heat-activated adhesive or an adhesive activated by water. In using such alternative adhesives, it will be appreciated that the release coating could be eliminated from the label, if desired.

As used herein, the term “permanent adhesive” refers to an adhesive that is operable to adhere the stock 30 to the package P or another substrate, with removal of at least part of the stock 30 from the package P resulting in physical damage to either the stock 30 or the package P, with the damage being visibly evident to the naked eye. In this manner, the use of permanent adhesive serves to make the applied label 26 tamper-evident. However, according to some aspects of the present invention (see below), the adhesive layer could alternatively be formed of a temporary adhesive, i.e., adhesive that permits label removal without visibly damaging the stock 30 or package P. Furthermore, another mechanism could be used to cause the label 26 to be tamper-evident.

The label 26 preferably includes side perforations 74 and end perforations 76a,b,c that permit the label 26 to be separated into a removable center label section and a surrounding label section (see FIGS. 1 and 2). In particular, the perforations 74,76a,76c are preferably aligned with the inner adhesive margin 62 so that the removable center label section and the central section 70 of the stock 30 are substantially co-extensive. Most preferably, the perforations 74,76a,76c cooperatively provide an endless line of weakness that defines the central section 70 and the border section 72, with the central section 70 being entirely removable from the endless border section 72.

However, for some aspects of the present invention, the central section 70 may not be defined by perforations (e.g., where the label 26 is devoid of perforations 74,76). It is also within the ambit of the present invention where the perforations 74,76a,76c are spaced inwardly from the inner adhesive margin 62 (e.g., to ensure that no adhesive is applied to the removable center label section) or outwardly from the inner adhesive margin 62 (e.g., to permit limited adhesive engagement between the removable center label section and the package P when the label 26 is applied to the package P).

Perforation 76b extends along the central section 70 between perforations 74 and is inwardly spaced from and adjacent to perforation 76c. Perforations 74,76b,76c cooperatively define a tear strip 78 of the central section 70 that provides removable interconnection between the sections 70,72 of the stock 30 and, more importantly, facilitates removal of the central section 70. Specifically, the illustrated tear strip 78 is removable to present an unsupported margin 80 of the central section 70 adjacent an end of the label 26 (see FIG. 5). The unsupported margin 80 permits a user to grab the label top 44 and label bottom 46 along the margin 80 and remove the central section 70 from the endless border section 72 by pulling the margin 80 in a direction toward the opposite end of the label 26 (see FIG. 6). The illustrated tear strip 78 is preferably positioned at one end of the central section 70, but could be alternatively positioned (e.g., along one side of the central section 70) without departing from the scope of the present invention.

The label 26 preferably includes the illustrated perforations 74,76. However, as will be shown in subsequent embodiments, an alternative label could employ a different arrangement of perforations (e.g., to provide an alternative tear strip). Also, for some aspects of the present invention, an alternative label could be devoid of perforations. In such an alternative embodiment, the label could be provided with a temporary adhesive so that the entire label can be selectively removed from the package to expose any hidden indicia. Yet further, in accordance with certain aspects of the present invention, the label may alternatively be provided with different means for facilitating removal of the central portion or no means whatsoever, as noted. As an example, the label may be provided with a small opening adjacent the central portion (or some other form of pick point) to provide a location where the central portion is grasped for removal.

Turning to FIGS. 1 and 2, the printed label 26 includes top and bottom indicia 82,84 on the label top 44 and the label bottom 46, respectively. As will be described, the indicia 82,84 may include variable indicia (i.e., indicia that can vary with each label and associated package P) and non-variable indicia (i.e., indicia that generally does not change from label to label or from order to order). Furthermore, some of the indicia may be preprinted (e.g., before the single-ply substrate is wound into roll 22).

The top indicia 82 presented on the label top 44 includes sender address indicia 86, recipient address indicia 88, package size and package number indicia 90, bar code indicia 92 operable to provide a unique identifier associated with the package P that can be electronically scanned, package tracking indicia 94 operable to identify the carrier and a unique carrier tracking number associated with the package, and tear strip indicia 96 (see FIG. 1). The top indicia 82 illustrated on the label top 44 is all printed on the central section 70, but the principles of the present invention are applicable where at least some indicia is printed on the endless border section 72. As will be discussed further, the top indicia 82 is generally exposed and visible when the label 26 is applied to the package P.

The bottom indicia 84 presented on the label bottom 46 includes non-variable indicia 98, package contents indicia 100 that provides an itemized list of the package contents, and tear strip indicia 102. The package contents indicia 100 comprises variable indicia that identifies the contents of the corresponding package P. However, it will be appreciated that the bottom indicia could include alternative types of variable indicia. For instance, the variable indicia could include a greeting or other message associated with a particular recipient. Furthermore, as will be shown in subsequent embodiments, the bottom indicia could include other types of packing list indicia.

The bottom indicia 84 illustrated on the label bottom 46 includes information confidential to the sender and recipient. Therefore, the bottom indicia 84 is printed on the central section 70 and is generally hidden from view when the label 26 is applied to the package P. However, the principles of the present invention are applicable where at least some indicia printed on the label bottom is printed on another portion of the label bottom(e.g., where part of the bottom face extends outside of the adhesive border and is configured to receive printed indicia). In such an alternative arrangement, some of the indicia on the label bottom 46 could be viewable without removing the applied label 26.

Although not printed on the central section 70, the label 26 also preferably includes timing mark indicia 48. The indicia 48 is preferably printed in a section of the bottom face 42 within the border section that is devoid of adhesive.

The top and bottom indicia 82,84 are preferably printed by direct-thermal printing, but each of the indicia 82,84 could be printed by other printing methods, such as laser reactive marking. It is also within the scope of the present invention where the top indicia 82 is printed by one printing method and the bottom indicia 84 is printed by a different printing method. For instance, one of the indicia 82,84 could be printed by direct-thermal printing and the other one of the indicia 82,84 could be printed by laser reactive marking. For some aspects of the present invention, the label could include additional indicia printed by thermal transfer, laser, or ink jet printing. Furthermore, the top indicia 82 may alternatively be printed without using thermally reactive coatings. For example, according to some aspects of the present invention, some or all of the top indicia may be ink jet or laser jet printed.

The indicia 86,96,98,102 generally comprise non-variable indicia. Indicia 88,90,92,94,100 generally includes variable indicia. Thus, both faces of the label 26 include variable indicia, and variable indicia on both faces of the label 26 can be associated with a particular order for the contents of package P. As will be discussed further, in printing indicia on both label faces, the indicia on the label top 44 can be matched with the indicia on the label bottom 46 to provide all of the indicia associated with the corresponding order. This facilitates proper shipment of the correct items to the correct recipient.

The illustrated label 26 is configured so that confidential indicia, such as the package contents indicia 100, is only located on the label bottom 46 along the central section 70 and is thereby hidden when the label 26 is applied to package P. Thus, the label 26 must be at least partly removed from the package P to access the confidential indicia. Due to the preferred tamper-evident label construction, the label 26, the package P, or both are visibly damaged when the label 26 is at least partly removed from the package P.

The top and bottom indicia 82,84 comprise the only information associated with the package P that is carried by the illustrated label 26 for visual and electronic identification (by the sender, distributor, or recipient) of the package P and the associated order. But it is also within the ambit of the present invention where the label 26 includes other package or order identification features, e.g., other types of machine-readable features. For instance, the label 26 could include an RFID tag attached to the stock 30, with the tag being programmable, readable, and capable of carrying information in electronic form.

Turning again to FIGS. 1-4, the illustrated label 26 preferably includes the top and bottom print coatings 36,38 that are configured to be selectively activated to provide top and bottom indicia 82,84. As will be discussed, the print coatings 36,38 each preferably comprise a selectively activated print coating that is preapplied to a corresponding face 40,42 of the label stock 30.

The print coatings 36,38 each preferably include a direct thermal print coating material that is selectively activated to form the corresponding indicia 82,84. In the usual manner, the indicia is formed by applying heat to the coating material with a corresponding direct thermal print head 58,60. Thus, each print head 58 or 60 applies heat to the respective print coating 36 or 38 so as to create the printed indicia within the respective print coating 36 or 38.

However, one or both of the print coatings 36,38 could include an alternative activated coating material. For instance, one or both of the print coatings 36,38 could include a laser reactive marking (LRM) material that is selectively activated by a laser (not shown), such as a carbon dioxide laser. That is, the laser operates as a print head to apply light (and heat) to the print coating 36,38 to print the indicia on the print coating 36,38.

The principles of the present invention are also applicable where the print coatings 36,38 include a combination of coating materials (e.g., where the print coatings 36,38 include a direct thermal coating material and a laser reactive marking coating material).

In general, direct thermal print coating and laser reactive marking print coating both generally comprise a heat-reactive coating that is printed by applying heat to the coating without transferring ink to the coating. It is also within the ambit of the present invention where one or both of the print coatings include another type of heat-reactive print coating. Furthermore, for some aspects of the present invention, one or both of the print coatings 36,38 could include a coating material that is alternatively activated (e.g., where the coating is activated by exposure to water, another liquid, or a gas).

The top print coating 36 preferably comprises a continuous layer of activated print coating material that is applied to and substantially covers the top face 40 of the label stock 30 (see FIGS. 1 and 4). As a result, the top print coating 36 extends up to the edges 35a,b of the label 26. Consequently, the top print coating 36 makes the entire area of the label top 44 printable by direct thermal printing.

However, the top print coating 36 could be alternatively configured without departing from the scope of the present invention. For instance, the top print coating 36 could be applied to only part of the top face 40. For example, the top print coating 36 could alternatively form a coating edge spaced from at least one of the label edges 35a,b, whereby only part of the label top 44 is configured for printing.

It is within the ambit of the present invention where an alternative label includes one of various configurations of a partial top print coating. In one alternative embodiment, the top print coating could be applied to cover the top face 40 of the central section 70 and part of the top face 40 of the border section 72. Similarly, another alternative top print coating could be applied to cover the top face 40 of the central section 70, but with the border section 72 being devoid of the top print coating. Also, the top print coating could be applied to cover only part of the top face 40 of the central section 70.

The illustrated top print coating 36 preferably comprises a continuous and unitary area of print coating. However, it will be appreciated that the top print coating could include a plurality of discrete and spaced apart areas (i.e., sections) ofprint coating. As noted, according to some aspects of the present invention, an alternative label could be devoid of a top print coating. That is, the top face could be entirely devoid of print coating material.

For some aspects of the present invention, at least some of the top indicia 82 could be printed without the use of an activated print coating. For instance, at least some of the top indicia could be printed by thermal transfer printing, laser printing, or ink jet printing. Furthermore, the top indicia could be printed using a combination of printing with activatable print coating and printing using more traditional non-activatable coatings (or no coatings at all). Yet further, in some embodiments, the top face could be devoid of activated print coating material.

The bottom print coating 38 preferably comprises a continuous layer of activated print coating material that is applied to and covers only part of the bottom face 42 of the label stock 30 (see FIGS. 2 and 4). In particular, the bottom print coating 38 defines a printable portion of the label bottom 46. That is, because the bottom face 42 is not fully coated with the bottom print coating 38, the label bottom 46 is only partially printable by direct thermal printing.

The printable portion defined by the bottom print coating 38 is preferably devoid of adhesive. However, for some aspects of the present invention, the label bottom 46 could have not insignificant sections thereof having overlapping print and adhesive layers, although this will occur outside of the printable portion, as will be described.

In the illustrated embodiment, the bottom print coating 38 includes multiple areas 104a-d (i.e., sections) of print coating with coating edges 106 (see FIG. 2). The illustrated areas 104 are preferably spaced apart from one another. The illustrated areas 104 of bottom print coating 38 are also preferably spaced inboard from the adhesive layer 34. However, as will be shown in subsequent embodiments, the bottom print coating could be alternatively applied to extend up to the adhesive layer 34.

The illustrated adhesive layer 34 defines an adhesive portion of the label bottom 46, and it is important with any embodiment for the printable portion (defined in the present embodiment by the areas 104a-d) and the adhesive portion to be nonoverlapping. In other words, the label bottom 46 includes a part thereof with printable coating but no adhesive, and a separate part thereof with adhesive but no printable coating. It shall be understood, however, that insignificant overlapping of the printable coating and adhesive is permissible without departing from the spirit of the present invention or the meaning of the term “nonoverlapping” as used herein. That is to say, in embodiments where no spacing is provided between at least parts of the printable and adhesive portions, a small degree of overlap (likely inadvertent or due to manufacturing tolerances) is permitted, provided that such overlap has a maximum dimension of less than about five millimeters (5 mm) and, most preferably, less than about one millimeter (1 mm). Furthermore, the nonoverlapping printable and adhesive portions of the label bottom 46 need not collectively make up the entirety of the label bottom. It is possible according to certain aspects of the present invention for significant overlapping of adhesive and printable coating to occur in other areas of the label bottom. The invention simply involves having at least one area of printable coating having no adhesive (the printable portion) and at least one area of adhesive having no printable coating (the adhesive portion). Again, in the first embodiment, the printable areas 104a-d collectively make up the printable portion, and the adhesive layer 34 (preferably formed in an endless border) makes up the adhesive portion.

The bottom print coating 38 could also be alternatively configured to include an alternative number of areas 104 (i.e., sections) of print coating. For instance, the bottom face 42 of central section 70 could have three (3) print coating areas 104a,b,c, while the bottom of tear strip 78 is devoid of print coating. For some aspects of the present invention, at least some of the bottom indicia 84 could be printed without the use of an activated print coating. For instance, at least some of the bottom indicia could be printed by thermal transfer printing, laser printing, or ink jet printing. Furthermore, the bottom indicia could be printed using a combination of printing with activatable print coating and printing using more traditional non-activatable coatings (or no coatings at all). In any event, it is still preferable that the label bottom 46 includes a spot of bottom print coating on the bottom face of the label for printing indicia on the label bottom.

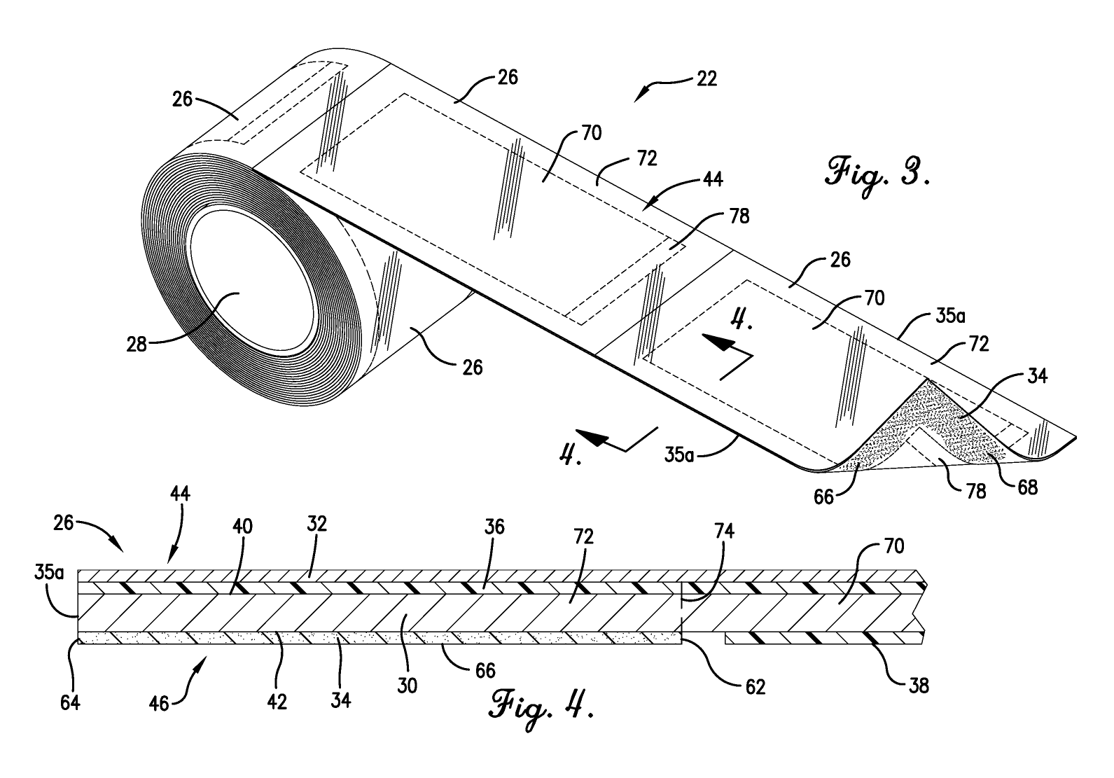

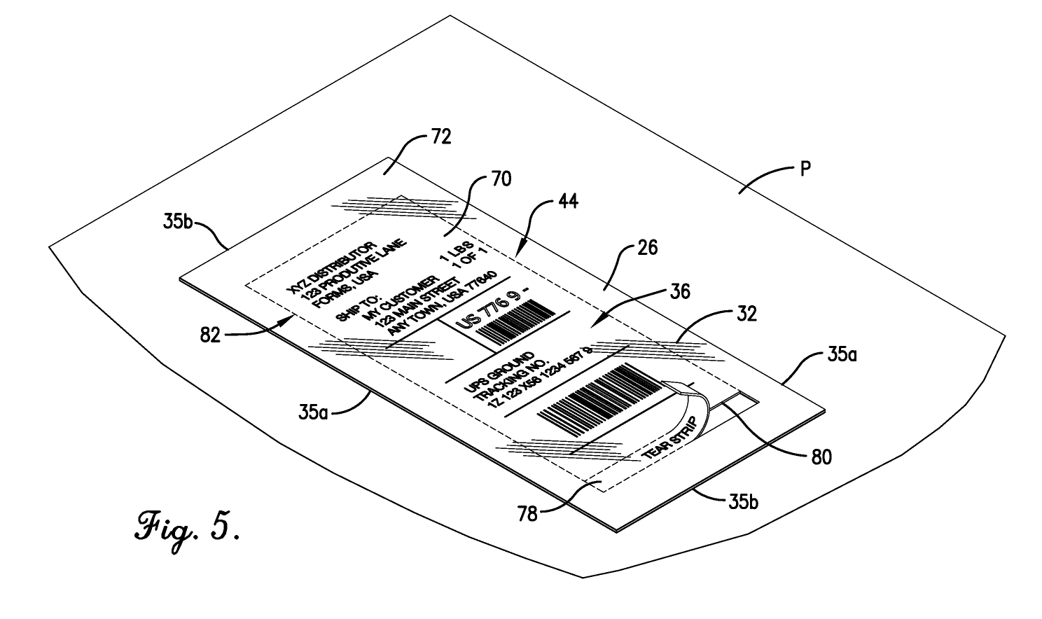

In use, the duplex label system 20 is operable to efficiently apply labels 26 to multiple packages while minimizing label waste and incidences of equipment failure. The label roll 22 dispenses the continuous web of labels 26 into the printer 24 by unrolling a label 26 from overlaid adhesion with at least one other label 26 (see FIGS. 3 and 7). That is, an outer label 26 is unrolled from an adjacent inner label(s) 26 by separating the adhesive face of the outer label 26 from the adhesive-free face of the inner label 26. Again, the illustrated labels 26 include only limited pre-printed indicia, if any.

Turning to FIGS. 5-8, as labels 26 pass from the form inlet 55 of the printer 24 to the form outlet 56 in a single printing pass, indicia 82,84 is printed on the label top 44 and the label bottom 46 (see FIGS. 7 and 8). The printed labels 26 then pass out of the form outlet 56 and into the cutter 50 so that the end-most label 26 is separated from the rest of the continuous web. The separated label 26 is then positioned adjacent the package P, and the label applicator 52 adheres the label 26 onto the package P in a flat and unfolded condition (see FIG. 7). The bottom face 42 of the adhered label 26 is positioned in adhesive engagement with the package P, and the bottom indicia 84 printed on the label bottom 46 is thereby hidden by the adhered label 26 and package P in a secured label configuration. In addition, the label top 44 is exposed to permit viewing and electronic scanning of top indicia 82 printed thereon.

The system 20 is configured to print and apply labels 26 to corresponding packages P, with the indicia on each side of the label 26 being matched with each other and with the package P. The bottom indicia 84 printed along the central section 70 is exposed for viewing by first removing (or at least partially removing) the tear strip 78 to present the unsupported margin 80 of the central section 70 (see FIG. 5). The recipient can then grasp the exposed margin 80 to remove the central section 70 from the endless border section 72 (see FIG. 6), with the central section 70 thereby serving as a packing slip (or packing list). Without departing from the scope of the present invention, the illustrated central section 70 could alternatively be used and/or referred to as a carton contents list or an invoice.

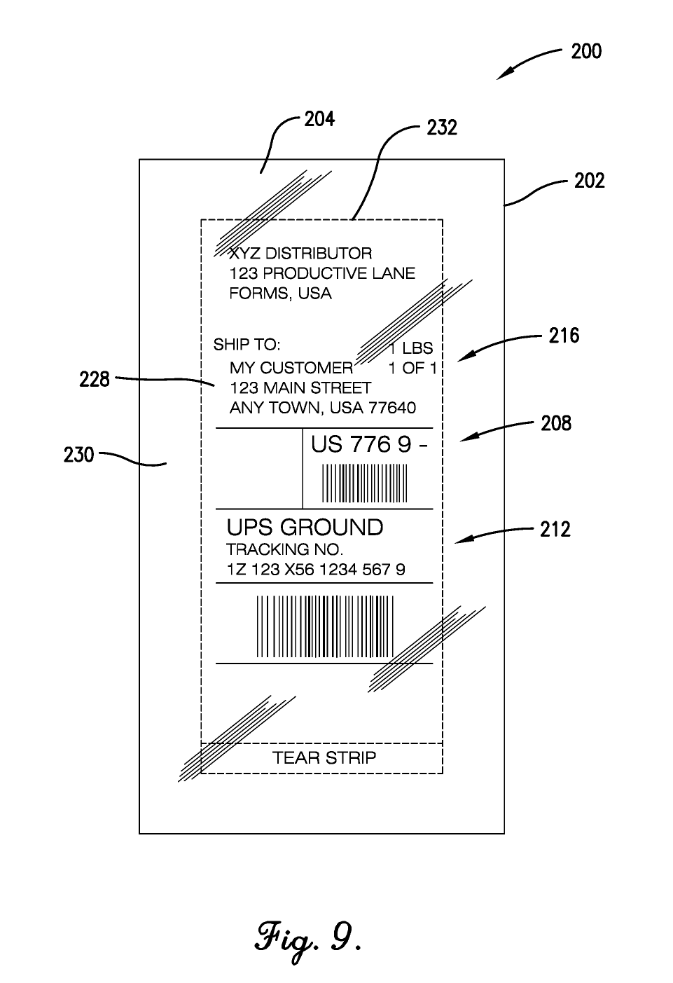

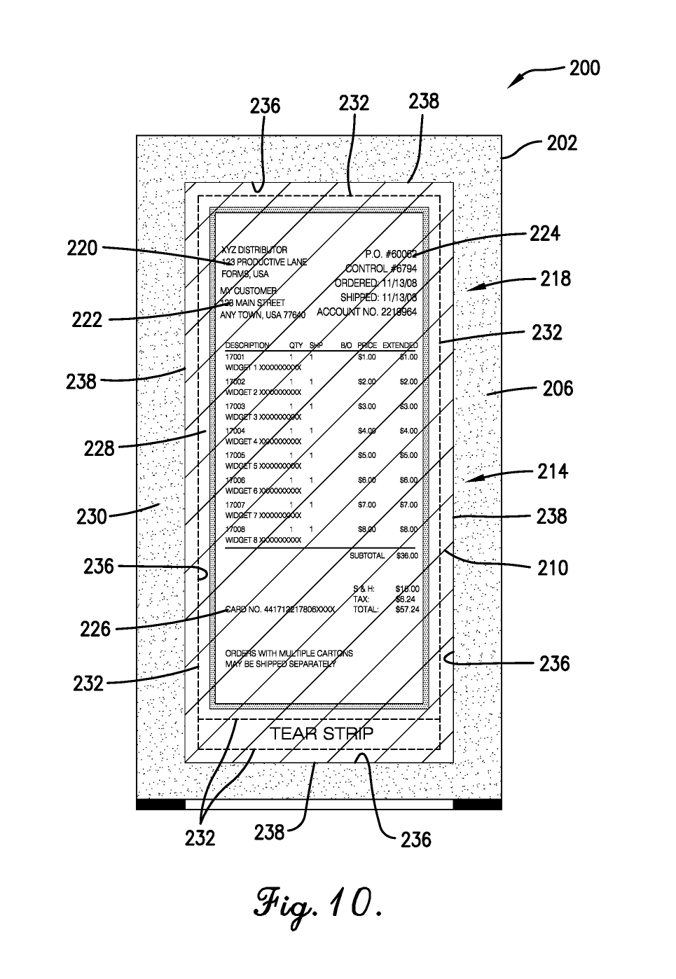

Turning to FIGS. 9-14, alternative preferred embodiments of the present invention are depicted. For the sake of brevity, the remaining description will focus primarily on the differences of these alternative embodiments from the preferred embodiment described above.

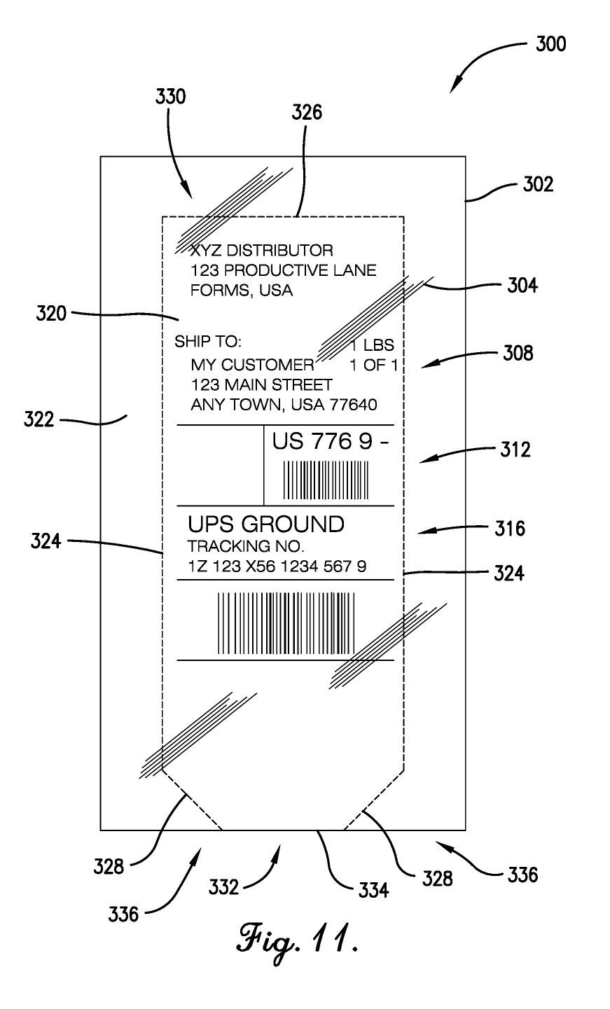

Initially turning to FIGS. 9 and 10, an alternative duplex label 200 is constructed in accordance with a second embodiment of the present invention. The label 200 is configured to receive packing and shipping information and includes thermal printer stock 202, release coating 204, alternative adhesive layer 206, a top activated print coating 208, and an alternative bottom activated print coating 210.

The printed label 200 also includes a label top 212, label bottom 214, top indicia 216, and alternative bottom indicia 218. The bottom indicia 218 presented on the label bottom 214 includes, among other things, sender address indicia 220, recipient address indicia 222, purchase order indicia 224, and package contents and billing indicia 226. The bottom indicia 218 illustrated on the label bottom 214 includes information confidential to the sender and recipient.

The stock 202 preferably includes a central section 228 and an endless border section 230 that are separated by perforations 232. The adhesive layer 206 extends endlessly about the central section 228. The adhesive layer 206 presents an inner adhesive margin 236 that is spaced outboard of the central section 228 and the perforations 232,234.

The bottom print coating 210 preferably comprises a continuous layer of activated print coating material that is printable by direct thermal printing. The bottom print coating 210 is applied to and covers part of the bottom face of the label stock 202. In the illustrated embodiment, the bottom print coating 210 is applied to the central section 228 and to an inner margin of the border section 230. The bottom print coating 210 extends continuously across perforations 232.

In the illustrated embodiment, the bottom print coating 210 includes a single continuous area of print coating with coating edges 238. The illustrated area ofprint coating 210 preferably extends up to the adhesive layer 206 and is preferably nonoverlapping with respect to the adhesive layer 206.

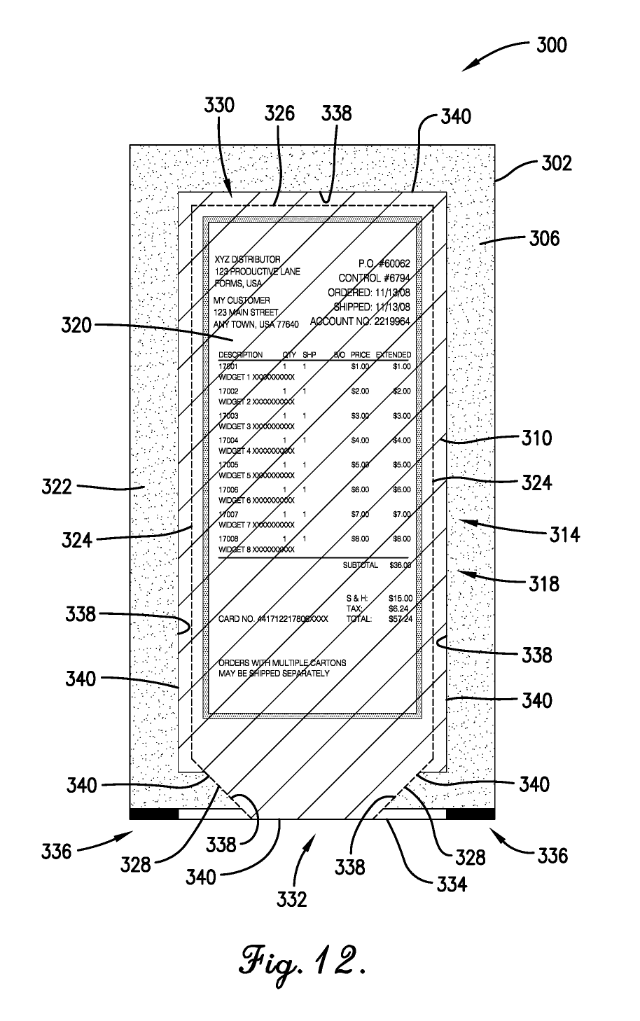

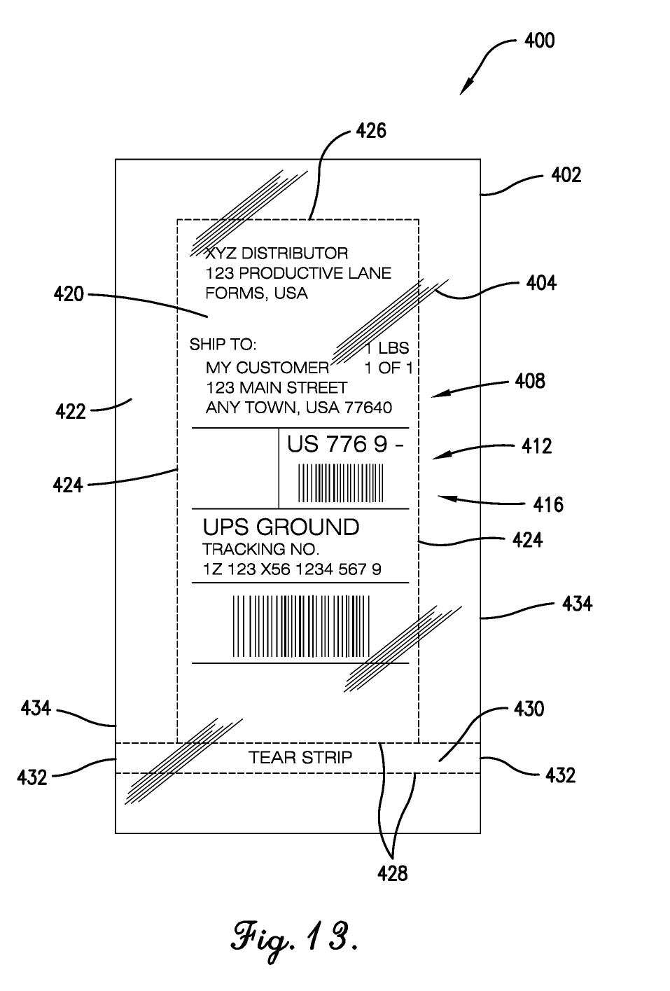

Turning to FIGS. 11 and 12, an alternative duplex label 300 is constructed in accordance with a third embodiment of the present invention. The label 300 is configured to receive packing and shipping information and includes thermal printer stock 302, release coating 304, alternative adhesive layer 306, a top activated print coating 308, and an alternative bottom activated print coating 310.

The label 300 also preferably includes a label top 312, label bottom 314, top indicia 316, and bottom indicia 318.

The stock 302 preferably includes a central section 320 and a border section 322 that are separated by side perforations 324 and end perforations 326,328. The central section 320 is preferably unitary and includes opposite ends 330,332. One of the ends 332 is unadhered in the sense that it extends to an end edge 334 of the label 300 and is thereby not “protected” or “supported” by the adhesive layer 306 along part of the label edge 334. The border section 322 extends partly around the central section 320 to present border ends 336. The end perforations 326 and 328 are defined between the border ends 336 and the central portion 320 to provide a detachable connection therebetween.

The adhesive layer 306 extends along the length of the border section 322. The adhesive layer 306 presents an inner adhesive margin 338 that is located outboard of the central section 320 and the perforations 324,326,328. The central section 320 is preferably devoid of adhesive so that the unadhered end 332 is not adhered to the corresponding package. As a result, the central section 320 can be selectively removed from the border section 322 by grasping and drawing the unadhered end 332 toward the supported end 330.

The bottom print coating 310 preferably comprises a continuous layer of activated print coating material that is printable by direct thermal printing. The bottom print coating 310 is applied to and covers only part of the bottom face of the label stock 302. In particular, the bottom print coating 310 defines a printable portion of the label bottom 314.

In the illustrated embodiment, the bottom print coating 310 includes a single continuous area ofprint coating with coating edges 340. The illustrated area of print coating 310 preferably extends up to the adhesive layer 306 and is preferably nonoverlapping with respect to the adhesive layer 306. The bottom print coating 310 also preferably extends up to the end edge 334 of the label 300.

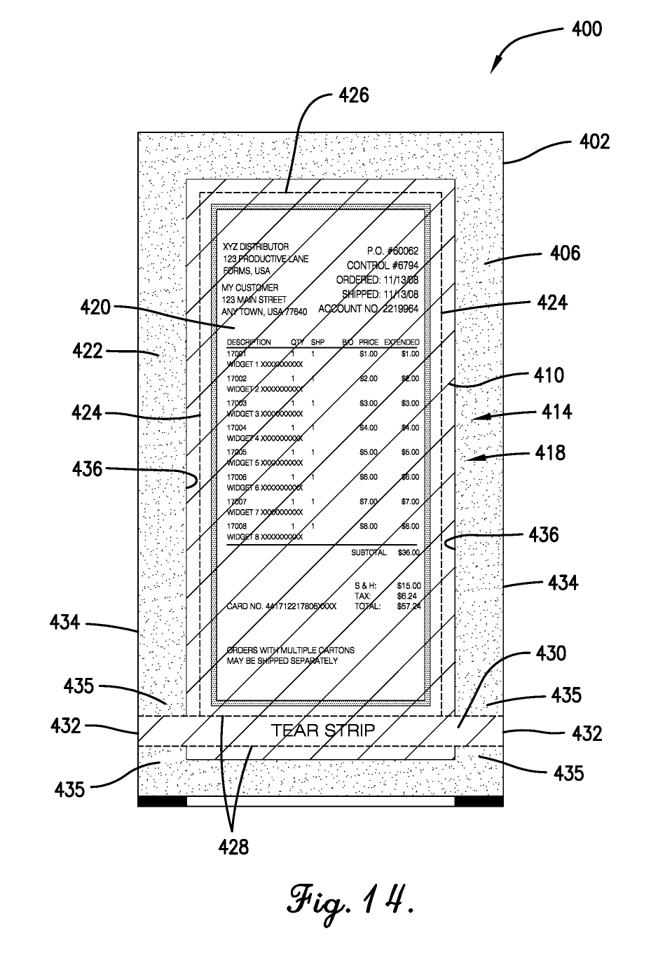

Turning to FIGS. 13 and 14, an alternative duplex label 400 is constructed in accordance with a third embodiment of the present invention. The label 400 is configured to receive packing and shipping information and includes thermal printer stock 402, release coating 404, alternative adhesive layer 406, a top activated print coating 408, and an alternative bottom activated print coating 410.

The label 400 also preferably includes a label top 412, label bottom 414, top indicia 416, and bottom indicia 418.

The stock 402 preferably includes a central section 420 and a border section 422 that are separated by side perforations 424 and end perforations 426,428. The central section 420 preferably includes a tear strip 430 with unadhered ends 432. The ends 432 extend to opposite side edges 434 of the label 400. The border section 422 extends partly around the central section 420 and is separated into two spaced-apart sections by the tear strip 430. The border section 422 presents border ends 435 located on opposite sides of the tear strip 430.

The adhesive layer 406 preferably extends along part of the length of the border section 422. The adhesive layer 406 presents an inner adhesive margin 436 that is located outboard of the central section 420. The central section 420 is preferably devoid of adhesive. As a result, the tear strip 430 is also devoid of adhesive so that the unadhered ends 432 are not adhered to the corresponding package. As a result, the tear strip 430 can be selectively removed from the border section 422 by grasping and drawing either one of the unadhered ends 432 toward the other unadhered end 432. The adjacent end of the central section 420 can then be grasped to remove the central section 420 from the border section 422.

The bottom print coating 410 preferably comprises a continuous layer of activated print coating material that is printable by direct thermal printing. The bottom print coating 410 is applied to and covers part of the bottom face of the label stock 402. In particular, the bottom print coating 410 defines a printable portion of the label bottom 414.

In the illustrated embodiment, the bottom print coating 410 includes a single continuous area of print coating with coating edges 340. The area of print coating 410 preferably extends up to the adhesive layer 406 and is preferably nonoverlapping with respect to the adhesive layer 406. On the tear strip 430, the bottom print coating 410 also preferably extends up to the side edges 434 of the label 400. However, the tear strip 420 may alternatively be devoid of any print coating on the label bottom 414, if desired.

Although the above description presents features of preferred embodiments of the present invention, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together despite having been presented independently as part of separate embodiments in the above description.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A duplex label having a label top and a label bottom, with the label bottom configured to be adhered to a substrate, said duplex label comprising:
a label stock presenting opposite top and bottom faces that correspond to the label top and the label bottom, respectively,
said label top being printable to receive exposed indicia that is visible when the label is adhered to the substrate;
a pattern of adhesive applied to only part of the bottom face of the label stock so as to define an adhesive portion of the label bottom; and
an area of selectively activated print coating preapplied to only part of the bottom face of the label stock so as to define a printable portion of the label bottom,
said printable portion being operable to receive hidden indicia when the print coating is activated, with the hidden indicia being concealed cooperatively by the label stock and substrate until the label is at least partly removed,
said adhesive portion and said printable portion being nonoverlapping.

2. The duplex label as claimed in claim 1,
said label bottom having adhesive only within the adhesive portion and having print coating only within the printable portion, such that the label bottom is devoid of any overlapping adhesive and print coating.

3. The duplex label as claimed in claim 2,
said print coating being heat-reactive.

4. The duplex label as claimed in claim 3,
said print coating being configured for activation by direct thermal printing or by laser reactive marking.

5. The duplex label as claimed in claim 1,
said label stock presenting a continuous outer label edge,
said adhesive portion comprising an adhesive border that extends at least partly along the label edge to surround at least part of the printable portion.

6. The duplex label as claimed in claim 5,
said adhesive border being devoid of print coating.

7. The duplex label as claimed in claim 6,
at least part of said printable portion being spaced inboard of the adhesive border so that the printable and adhesive portions are at least partially spaced apart from one another.

8. The duplex label as claimed in claim 5,
said adhesive portion extending endlessly around the printable portion.

9. The duplex label as claimed in claim 5,
said adhesive border being discontinuous such that the label bottom is devoid of adhesive along part of the outer label edge.

10. The duplex label as claimed in claim 9,
said printable portion extending along said part of the outer label edge.

11. The duplex label as claimed in claim 1,
said label stock including a line of weakness that separates the label stock into a central section and a border section, with the border section being in a surrounding relationship to at least part of the central section,
said central and border sections cooperatively presenting the top and bottom faces of the label stock,
said print coating being applied to the central section and said adhesive being applied to the border section.

12. The duplex label as claimed in claim 11,
said print coating being applied only to the central section,
said border section being devoid of print coating.

13. The duplex label as claimed in claim 12,
said print coating being spaced inboard of the border section.

14. The duplex label as claimed in claim 11,
said adhesive extending endlessly around the printable portion.

15. The duplex label as claimed in claim 11,
said print coating being applied to the central section and the border section.

16. The duplex label as claimed in claim 15,
said adhesive extending endlessly around the printable portion.

17. The duplex label as claimed in claim 15,
said print coating extending to an outside edge of the label.

18. The duplex label as claimed in claim 11,
said label stock including a tear strip that removably connects the central and border sections to one another,
said tear strip being removable from the sections to present an unsupported margin of the central section.

19. The duplex label as claimed in claim 18,
said print coating being applied to the tear strip.

20. The duplex label as claimed in claim 1,
a top area of selectively activated print coating preapplied to at least part of the top face of the label stock so as to define a top printable portion of the label top,
said top printable portion being operable to receive exposed indicia when the top area of print coating is activated.

21. The duplex label as claimed in claim 20,
said top area of print coating covering the entire top face of the label stock.

22. The duplex label as claimed in claim 1,
said label stock comprising a single label ply that presents the top and bottom faces.
